(19) United States
(12) Patent Application Publication
(10) Pub. No.: US 2014/0357338 A1
(43) Pub. Date: Dec. 4, 2014

(54) Bingo game system with multiple game functionality

(71) Applicant: Pockaj D.O.O. (d.b.a. Alfastreet), Kozina (SI)

(72) Inventor: Iztok Pockaj, Lokev (SI)

(73) Assignee: Pockaj D.O.O. (d.b.a. Alfastreet), Kozina (SI)

(21) Appl. No.: 14/120,329

(22) Filed: May 14, 2014

Related U.S. Application Data
(60) Provisional application No. 61/823,300, filed on May 14, 2013.

(51) Int. Cl. A63F 3/06; G07F 17/32

(52) U.S. Cl. CPC A63F 3/062; G07F 17/3288
USPC 463/16

(57) ABSTRACT

A game system including a game station, a player input device, a communication device, and a controller. The game station includes a display device configured to display a user interface with a plurality of game options available for selection. Each game option is associated with a game play presentation, with at least one game options being a live bingo game. The player input device is in communication with the display device and receives selected game options, wherein game play presentations are displayed simultaneously on the display device responsive to the player selected game options. The communication device receives independent game data randomly generated for each of the selected game options. Finally, the controller processes the independent game data received by the communication device for each of the selected game options and facilitating independent game play presentations on the display device as a function of the independent game data.

### CROSS REFERENCE TO RELATED APPLICATIONS

This application claims priority to U.S. Provisional Application No. 61/823,300 entitled REMOTE GAMING TERMINAL AND. PLAYER INTERFACE, filed on May 14, 2013, the entirety of which is incorporated herein by reference.

### COPYRIGHT NOTICE

A portion of this disclosure contains material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### BACKGROUND

The invention is directed to wagering games, and more particularly, playing bingo-type games. The invention also generally relates to systems and methods for playing bingo-type games. More specifically, the invention relates to systems and methods for playing a bingo game that incorporates a roulette paradigm and game outcome display.

Bingo-type games are known in the art. For example, as is known, a traditional bingo game is played with bingo cards or tickets, which typically have a 5×5 grid. More specifically, this grid includes 5 columns and 5 rows, and the letters, “B,” “I,” “N,” “G,” and “O” are at the top of each column. Under each letter are five numbers, with the exception of the center space which is typically a free space. Therefore, there are typically 24 numbers. The numbers on the each bingo card are randomly established so that each bingo card is unique. The bingo cards further include a predetermined pattern or patterns, which are typically represented by a darkened segment in the traditional bingo game. Numbers are called, e.g. “I-20”, and players of the game daub, or otherwise, mark-off the number if they have it. Once a player achieves the predetermined pattern or patterns, and the player actually recognizes this achievement, he or she wins and the game is over.

Other bingo-type games include modern variations of the traditional bingo-type game. Some of these modern variations are played in a casino or gaming hall at a client, i.e., terminal. The client is also referred to as an electronic play station. These modern variations have various attractions and designs, including aesthetic symbols and both audio and visual animations, to attract players thereby increasing a level of play. As alluded to above, these modern variations are bingo-type games. However, there is recognition throughout industry that players of even the modern bingo-type games do not consider these games as exciting and attractive as standard gaming options, such as those offered at Las Vegas-style casinos which permit slots, roulette, craps and poker. Simply stated, the bingo-type games do not look and operate like these games. For this reason, the bingo-type games are not as appealing to patrons, which impacts the level of play as compared to that of the standard gaming options and is therefore less desirable to both the industry and players.

To this end, there have been efforts to maintain a bingo-type game, if required to do so by law, yet still create the ‘appearance’ of another game. These efforts have generally focused on making the bingo-type game appear as a standard slot machine by displaying a representation of a result of the bingo-type game, i.e., whether a player has won or lost, through a slot outcome. Therefore, although the player is playing the bingo-type game, and any payouts to the player are based on this bingo-type game, the player views one of an almost unlimited amount of slot machine outcomes as if it had been determined by the slot machine while the outcome displayed actually is a representation of the bingo-type game outcome.

Gaming establishments or casinos continually require new games to offer their players. It is therefore desirable to provide a new and unique bingo-type game that creates the perception of a roulette game rather than a slot machine, to heighten interest of the patrons that desire to play roulette in establishments that may only be able to offer bingo-type games. Naturally, casino operators seek to provide popular games for their gaming patrons.

Furthermore, players desire to play multiple games and participate in live action gaming events without having to leave their particular place within a gaming facility. Traditional gaming system require players to have to physically move to another location within the facility in order to play another game or to participate in a live action game.

Thus, there is a need for systems and methods which resolve one or more of the problems identified above, among other things.

### SUMMARY OF INVENTION

The invention is generally directed to systems and methods for providing a roulette and other wagering games through one or more electronic platforms.

Some embodiments of the invention are directed to a game system with multiple game functionality. The game system includes a game station, a player input device, a communication device, and a controller. The game station includes a display device configured to display a user interface with a plurality of game options available for selection. Each game option is associated with a game play presentation, with at least one game options being a live bingo game. The player input device is in communication with the display device and receives selected game options, wherein game play presentations are displayed simultaneously on the display device responsive to the player selected game options. The communication device receives independent game data randomly generated for each of the selected game options. Finally, the controller processes the independent game data received by the communication device for each of the selected game options and facilitating independent game play presentations on the display device as a function of the independent game data.

Some embodiments of the invention are directed to a method of implementing a game system with multiple game functionality including at least one game station including a display device, a player input device in communication with the display device, a communication device, and a controller. The method comprises the steps of: displaying a user interface through the display device, the user interface including a plurality of game options available for selection, each game option being associated with a game play presentation, wherein at least one of the plurality of game options is a live bingo game; receiving selected game options through the player input device; simultaneously displaying game play presentations on the display device in response to the player selected game options; receiving independent game data randomly generated for each of the selected game options; processing the independent game data received by the communication device for each of the selected game options; and facilitating the game play presentations on the display device as a function of the independent game data.

Finally, some embodiments of the invention are directed to a non-transitory information recording medium on which a computer readable program is recorded that causes a computer to function as a game system with multiple game functionality. The game system includes a game station, a player input device, a communication device, and a controller. The game station includes a display device configured to display a user interface with a plurality of game options available for selection. Each game option is associated with a game play presentation, with at least one game options being a live bingo game. The player input device is in communication with the display device and receives selected game options, wherein game play presentations are displayed simultaneously on the display device responsive to the player selected game options. The communication device receives independent game data randomly generated for each of the selected game options. Finally, the controller processes the independent game data received by the communication device for each of the selected game options and facilitating independent game play presentations on the display device as a function of the independent game data.

### BRIEF DESCRIPTION OF THE DRAWINGS

Other advantages of the invention will be readily appreciated as the same becomes better understood by reference to the following detailed description when considered in connection with the accompanying drawings:

FIG. 1 is a schematic representation of an exemplary system for allowing a player to play exemplary gaming methods according to an embodiment of the invention;

FIG. 2a is a front view of a game station constructed and configured according to an embodiment of the invention;

FIG. 2b is a side view of a game station constructed and configured according to an embodiment of the invention;

FIG. 2c is a top view of a game station constructed and configured according to an embodiment of the invention;

FIG. 3 is a schematic view of a game controller that may be used with the system shown in FIG. 1;

FIG. 4a is a cross-sectional view of the roulette feature constructed and configured according to the invention;

FIG. 4b is a close-up view of the cross-sectional view of FIG. 4a;

FIG. 4c is top view of an exemplary roulette feature such as the roulette feature shown in FIG. 4a;

FIG. 5 is a process flow chart illustrating an exemplary method of bingo-based roulette feature utilized within the invention;

FIG. 6 is a table illustrating the assignment of unique numbers to specific roulette outcomes;

FIG. 7-11 include graphical user interfaces illustrating game play on a system and using a method according to the invention;

FIG. 12 is a process flow chart illustrating an exemplary method of implementing a game system with multi game functionality; and

FIG. 13-25 illustrate various embodiments of the invention.

### DETAILED DESCRIPTION OF INVENTION

The exemplary embodiments herein relate to various systems and methods using in gaming applications.

The invention may be applied with a live game that includes one or more remote kiosks or gaming terminals. Each terminal is configured to receive and determine wagers based on one or more live games played at a nearby or remote location. The system is therefore configured to include devices which monitor the one or more live games, such as a roulette game, in which a physical reel or other gaming elements are activated or employed, and collect the game play data from each of the games. In some embodiments, the game play data is manually entered for collection by the system. The game play data collected is transmitted to the terminals and used to determine the outcome of wagers placed at the terminals. The terminals may be any apparatus or device capable of receiving and transmitting data, including devices which either process game play data or do not process game play data, including “thin-client” or “smart” devices. The terminals present the live game information for each of the live games on a display device and further include a data input device for facilitating the entry of wagers. Thus, players interested in placing wagers on a live game are not confined to a single location or even the casino floor as the

It should be understood that each of the methods and individual steps recited herein may be partially or wholly carried out in a variety of ways and/or systems, which may include, but are not limited to, an electronic gaming machine (EGM) for use by one or more players, a multiplayer platform which may include a player interface such as a touchscreen display and involve physical or virtual game symbols, a home computer and/or portable computing device, such as a tablet computer or mobile phone capable of communicating with a network or over the Internet, global telecommunication network or world wide web.

It should further be understood that the invention is directed to, among other things, methods of providing, conducting and resolving wagering games that include a sequence of controlled and concrete transformative events. Some of these events may involve communications between computing components, indicating preferences, placing wagers, debiting and awarding credits stored in an account, the generation of random data and results for one or more players, the application of randomly-generated data to resolve wagers, the pooling of all wagers placed, the determination of wager outcomes in accordance with preset outcome determining criteria, and the notification of such outcomes along with the designation of a portion of the wager pool for each player and simulated roulette game outcome. The generation of random data may be facilitated by computerized and/or physical implements, such as a random number generator. The transformative events may also include parsing of the data for comparative purposes with preset criteria to determine an outcome in the underlying bingo game.

Selected exemplary embodiments of the invention will now be explained with reference to the drawings. It will be apparent to those skilled in the art from this disclosure that the following description of exemplary embodiments of the invention is provided for illustration only and not for the purpose of limiting the invention as defined by the appended claims and their equivalents.

Referring to the figures, where like numerals indicate like or corresponding parts throughout the several views, systems and methods of the invention which are configured to cooperate with another in order to provide a bingo game with a roulette feature are described.

### System Generally

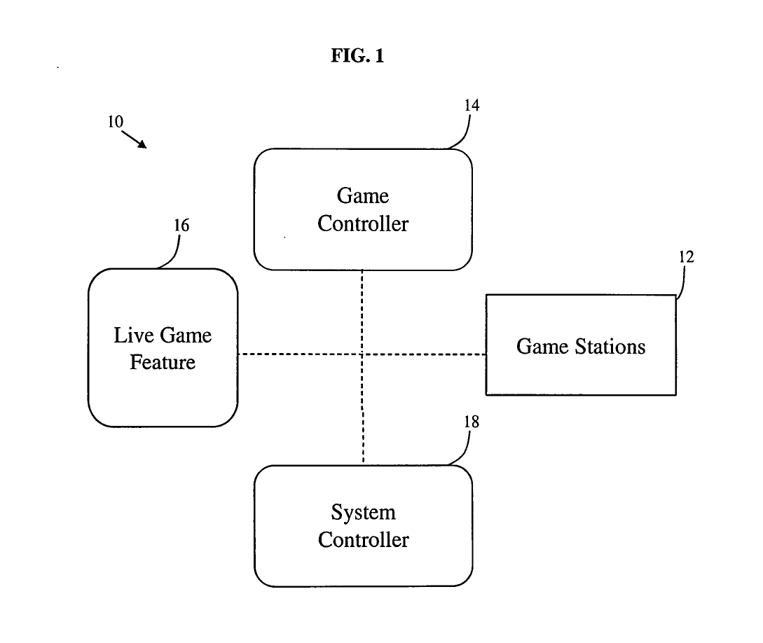

Referring to FIG. 1, a system 10 comprises one or more game stations 12, a game controller 14 and a live game feature 16. These components may be housed in a unitary housing or remotely positioned with respect to each other, while remaining in communication. Communication between these components may be facilitated by data communication devices connected over a wired or wireless network, using any conventional digital communication devices that are appropriate based on the locations of the system components.

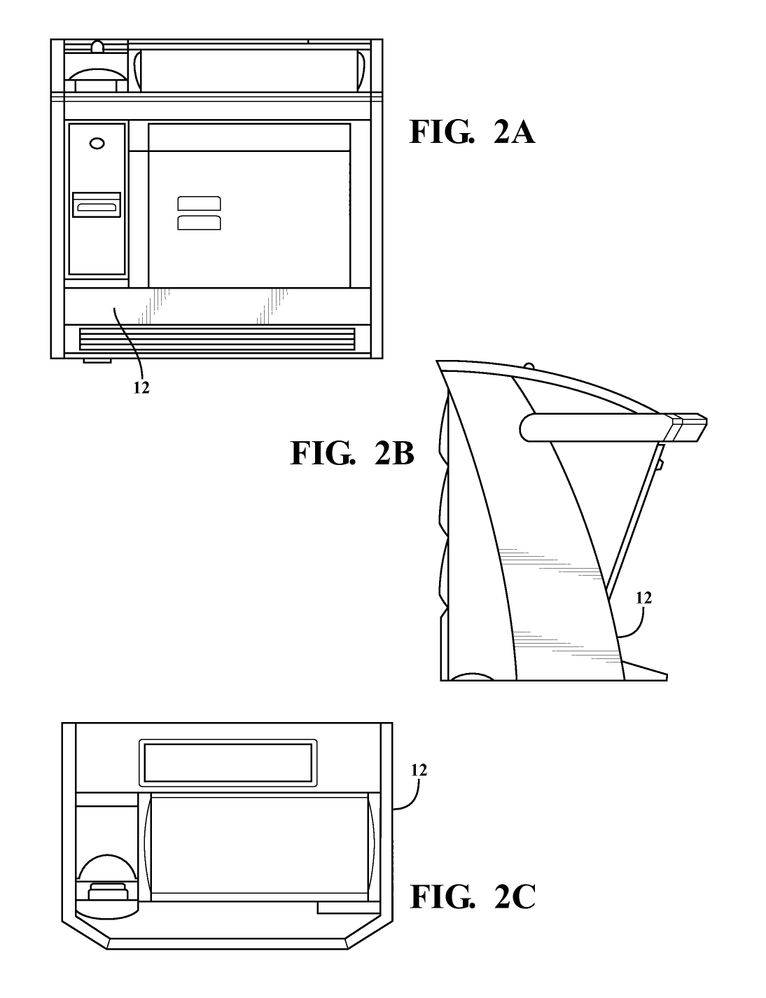

Each of the game stations 12 is used by the players in order to interact with the system and initiate game-play. Game stations 12 can take the form of player positions in a multi-player platform, electronic game machine cabinets or remote kiosks, but are not limited to such designs and may also be provided on smartphones, mobile computing devices, thin terminal devices, non-smartphone-type cellphones, tablets, laptops, or any other device configured to communicate within system 10. In some embodiments, game stations 12 include player input devices, such as keypads and display devices, or touchscreen displays, bill or ticket acceptors and printers, etc. One exemplary game station 12 is shown in FIGS. 2a,b,c.

In some embodiments the game system 10 includes a game station 12, a player input device, a communication device, and a controller. The game station includes a display device configured to display a user interface with a plurality of game options available for selection. Each game option is associated with a game play presentation, with at least one game options being a live bingo game. The player input device is in communication with the display device and receives selected game options, wherein game play presentations are displayed simultaneously on the display device responsive to the player selected game options. The communication device receives independent game data randomly generated for each of the selected game options. Finally, the controller processes the independent game data received by the communication device for each of the selected game options and facilitating independent game play presentations on the display device as a function of the independent game data.

In another embodiment of the present invention, the at least one game station 12 further includes a random number generator configured to generate independent game data in response to a player selected game option within the system. This allows every game station 12 within the game system 10 to handle a particular game option for the entire system. This reduces duplicative resources within the entire system while allowing for more game options to the players. Live game features 16 would also be available through independent hardware that is accessible within the game system 10.

In another embodiment of the present invention, the system further includes a system controller 18 configured to correlate the independent game data with the game option selected at the at least one game station. This separate system controller 18 may be attached to a live game feature 16 or operate independently in order to manage independent game data needed for a particular game option. The independent game data correlated by the system controller 18 generally related to progressive awards or points, multi-player gaming options utilized by the system, and multi-player gaming mechanics among others.

In another embodiment of the present invention, each game station 12 is further configured to automatically place a wager on the at least one game option available within the system through the at least one game station in response to the independent game data. This allows a player to continuously maintain themselves active within a gaming option or live gaming feature once the gaming option has been selected.

The game controller 14 may include one or more servers, random number generators, programs, databases, memory, data storage devices, data communication devices and data processing devices. Controller 14 is generally configured to manage the operation of bingo games as described herein by receiving wagers placed through game stations 12, providing virtual bingo cards or tickets to players, randomly drawn bingo numbers, determining if winning patterns are achieved and causing roulette feature 16 to simulate a roulette outcome. All or some of the components of game controller 14 may reside together or be variously integrated into other components of system 10, including game stations 12 and live game feature 16. Controller 14 may also include a security code secured keypad and or touchscreen device for use by authorized personnel.

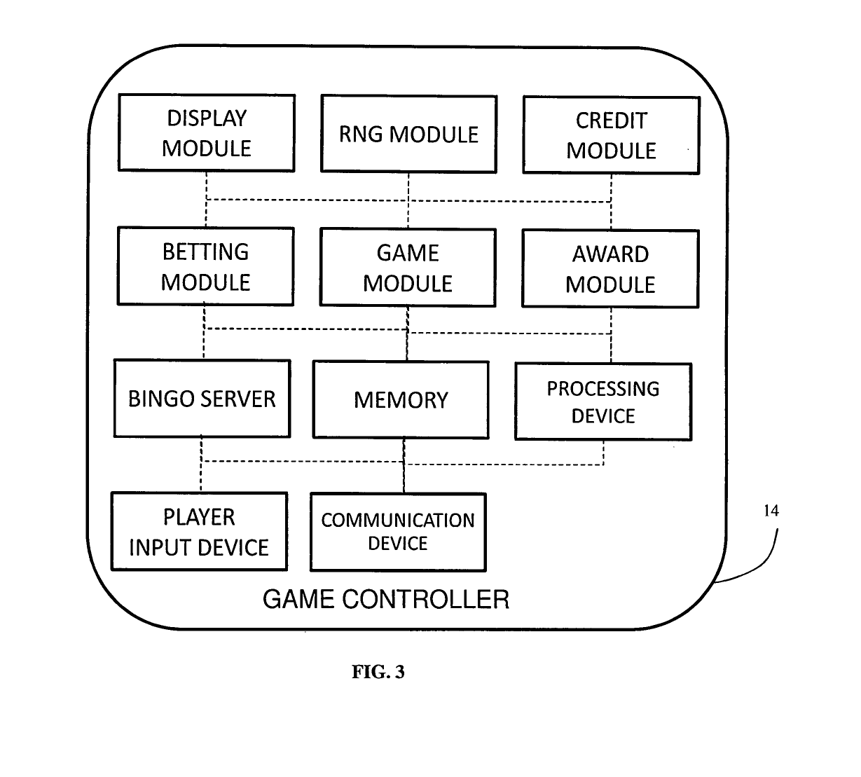

FIG. 3 illustrates some of the exemplary functionality expressed as modules in a game controller 14 which are facilitated by the aforementioned hardware and software components. Game controller 14 includes or is in communication with a display module, a random-number generator (RNG) module, a credit module, a betting module, a game module, and an award module, a bingo server, a processing device, a player input module, a communication device, and memory. The display module controls the display device on stations 12 to display various images on the graphical interfaces as discussed herein below, such as a roulette layout, preferably by using computer graphics and/or image data stored in the memory. The credit module communicates with a player account server to manage the amount of player's credits available for use in system 10 and converts currency or tickets received in stations 12 to credit. The game module includes a game program for use in providing gaming options in accordance with the invention. The game module may communicate with the bingo server to supply bingo cards or tickets to the stations 12 and communicate with the RNG module to obtain numbers from a pool of bingo numbers or balls. The betting module receives the player's wager information for resolving upon the conclusion of the game and the award module issues payouts for winning wagers. The player input device receives the player inputs in order to interact with the various gaming options and the gaming system 10 overall. The communication device maintains communication between the elements within the gaming system 10.

### Roulette Wheel Live Bingo Game Feature

In some embodiments of the present invention, outcomes of the underlying bingo game used within the live game feature 16 are presented through a roulette simulation provided by a roulette feature 116. Controller 14 determines the bingo game results based on randomly drawn numbers being compared to bingo tickets, which are then correlated to one of the possible outcomes on the roulette wheel, that is, either thirty-seven or thirty-eight possible outcomes depending on whether the wheel is a single-zero (“European”) roulette wheel or double-zero (“American”) roulette wheel.

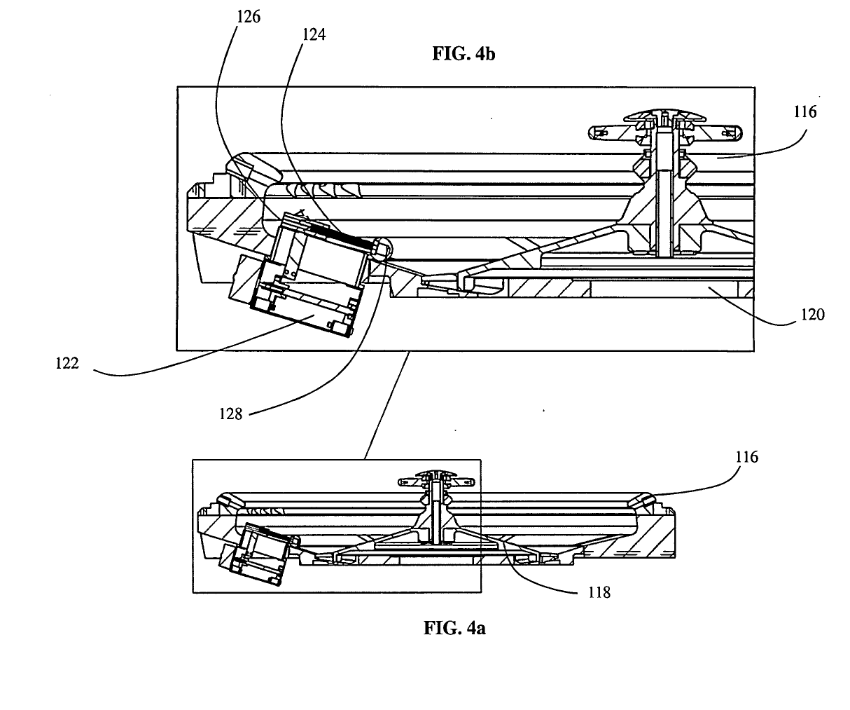

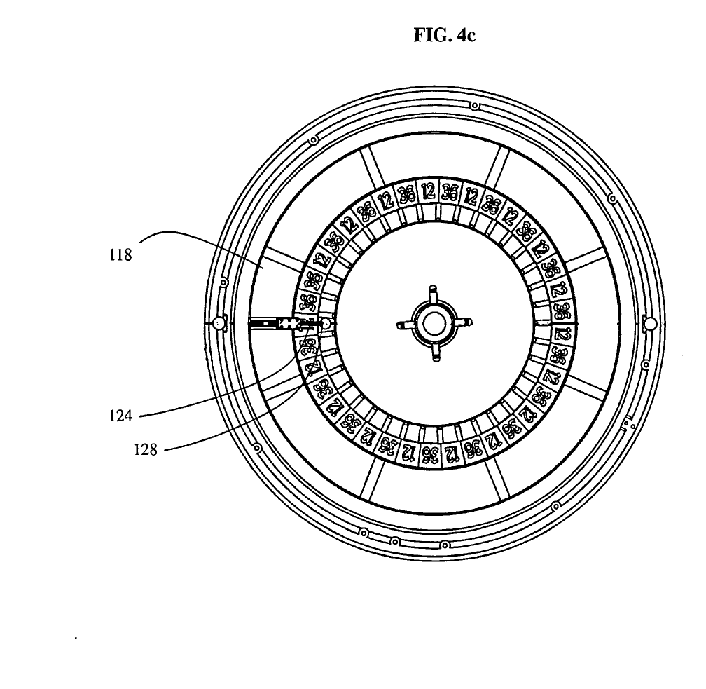

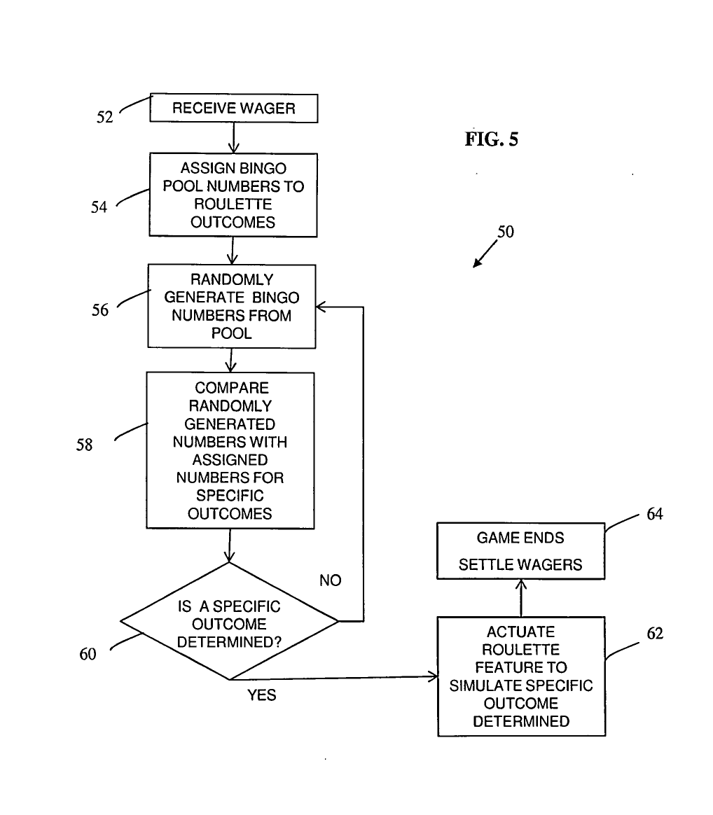

An exemplary roulette feature 116 is shown in FIG. 4a,b,c. The roulette feature 116 includes an electromechanical roulette wheel 118 configured for motor driven rotational motion via a motor 120 positioned adjacent to the central axis of wheel 118. In this embodiment, wheel 118 appears as a convention roulette wheel including pockets for receiving a roulette ball. Feature 116 further includes a static ball delivering apparatus 122 which is mounted adjacent to the periphery of wheel 118 but at a radially outer position relative to wheel 118. Apparatus 122 includes an arm 124 electromechanically connected thereto at a proximal end 126 and a sphere 128 configured to resemble a roulette ball at a distal end. Arm 124 is may be driven by a motor operatively associated with apparatus 122 to move sphere 128 from a position which does not obstruct or otherwise interfere with the rotational motion of wheel 118 to a position in which the sphere 128 is physically moved within or proximal to the volume defined by one of the pockets on the wheel 118. In operation, roulette wheel 118 may spin and stop under control of motor 120 so that a specific pocket is adjacent to apparatus 122 and arm 124 may drive sphere 128 into the specific pocket as shown in the exemplary roulette wheel 118 of FIG. 4c.

In some embodiments, roulette feature 116 may create suspense and game aesthetics by rotating wheel 118 at various speeds and durations of time, such as increasing and then decreasing speed until coming to a stop so that sphere 126 may be positioned in the pocket corresponding to the specific outcome.

In some embodiments, a roulette feature of the invention can be either fully virtual, that is provided by a display device, or a partially virtual apparatus. In some embodiments, wheel 118 may include lights in each pocket which illuminate to indicate a winning outcome. Additionally, it should be understood that a roulette wheel is a non-limiting example of the invention, in that other electromechanical or virtual simulated features may be employed with the invention, such as a customized wheel or big wheel apparatus.

### Method of Implementation for Roulette Bingo Based Live Game Feature

FIG. 5 shows an exemplary method 50 which may be utilized by system 10 to provide a bingo game with a live game feature 16, particularly using roulette wheel feature 116. In step 52, a wager is placed through a graphical user interface, which may be configured to resemble a conventional roulette table layout, displayed on a game station 12. In some embodiments, controller 14 one or more numbers in a finite pool of numbers are assigned to each specific roulette outcome in step 54. The gaming controller 14 may either randomly assign one or more numbers in a finite pool of numbers with a specific roulette outcome, or the assignments of one or more numbers to specific roulette outcomes may be preselected.

In step 56, bingo numbers from the finite pool are randomly generated via the gaming controller 14. In step 58 the gaming controller 14 determines if all of the one or more assigned numbers have been generated for any specific outcome. As shown by step 60, if a specific outcome has not yet been determined, then the gaming controller 14 continues to generate bingo numbers. If a specific outcome has been determined, then the gaming controller 14 actuates roulette feature 16 to simulate a roulette outcome which corresponds to that specific outcome in step 62. In step 64, the game ends once a specific outcome is determined and wagers are settled with losing wagers being collected while winning wagers being paid by adding credits at the appropriate station 12.

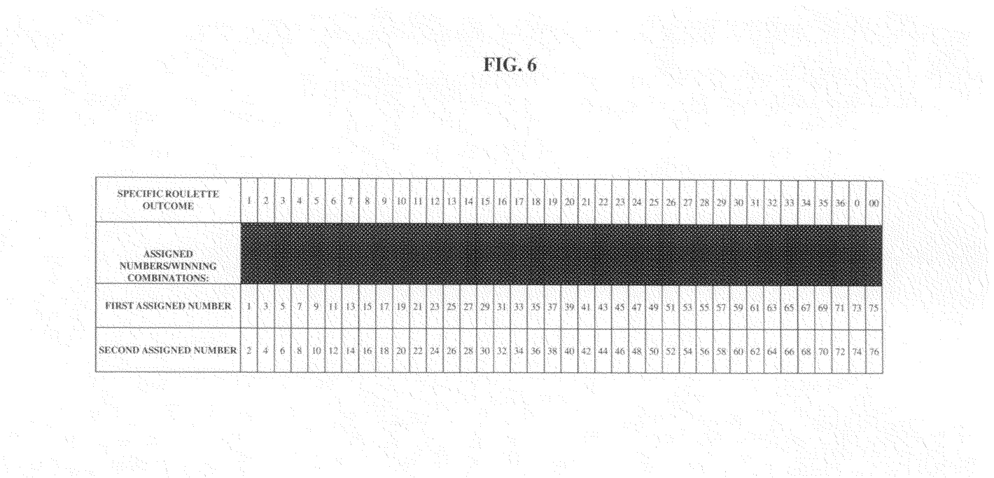

FIG. 6 illustrates an embodiment of method 50 in which each of the thirty-eight roulette outcomes are associated with two unique numbers from a finite pool of seventy-six numbers, which in this instance ranges from the number one to the number seventy-six. Thus, if the randomly generated bingo numbers include the two unique numbers for any specific roulette outcome, the game ends and roulette feature 16 simulates the specific outcome associated with those two unique numbers. In this embodiment, the numbers are sequentially ordered and assigned to each specific possible roulette outcome (that is, the numbered outcomes 0,00, and 1-36). For example, the preselected first and second unique numbers assigned to the specific roulette outcome of “6” are “11” and “12.” Thus, a player wagering on the roulette outcome of “6” in a game method 50 would win if bingo numbers “11” and “12” were randomly generated via controller 14 before the first and second unique numbers for another specific outcome had been generated. Roulette feature 16 would then simulate a roulette outcome of “6.” It should be understood that the pool of numbers may vary, which may also impact game play and duration until a winning outcome is determined. The size of the pool of numbers may also vary if there are a different number of possible outcomes, such as when using a single-zero roulette wheel or other type of mechanical wheel.

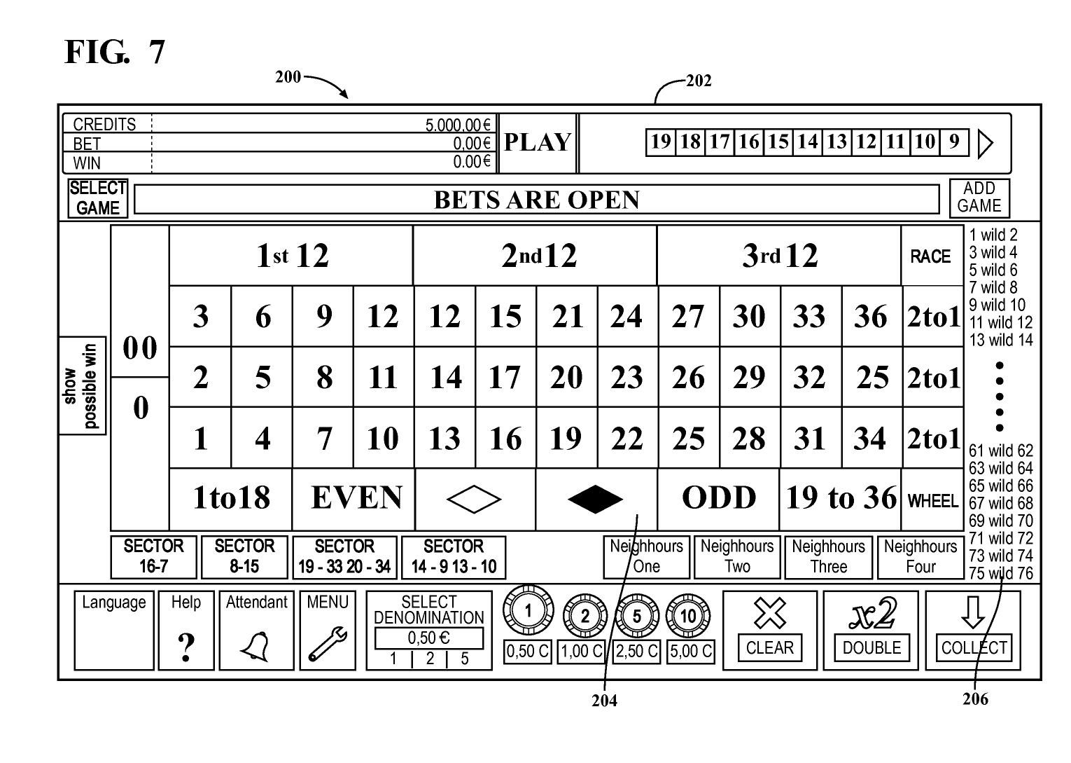

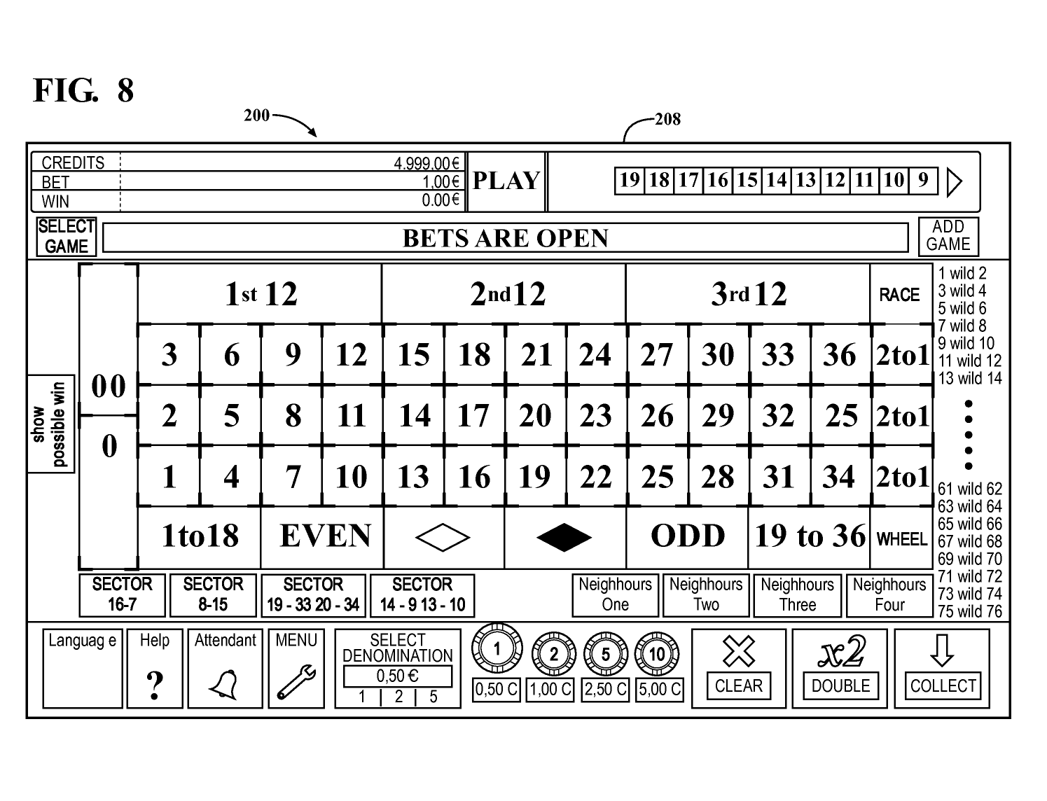

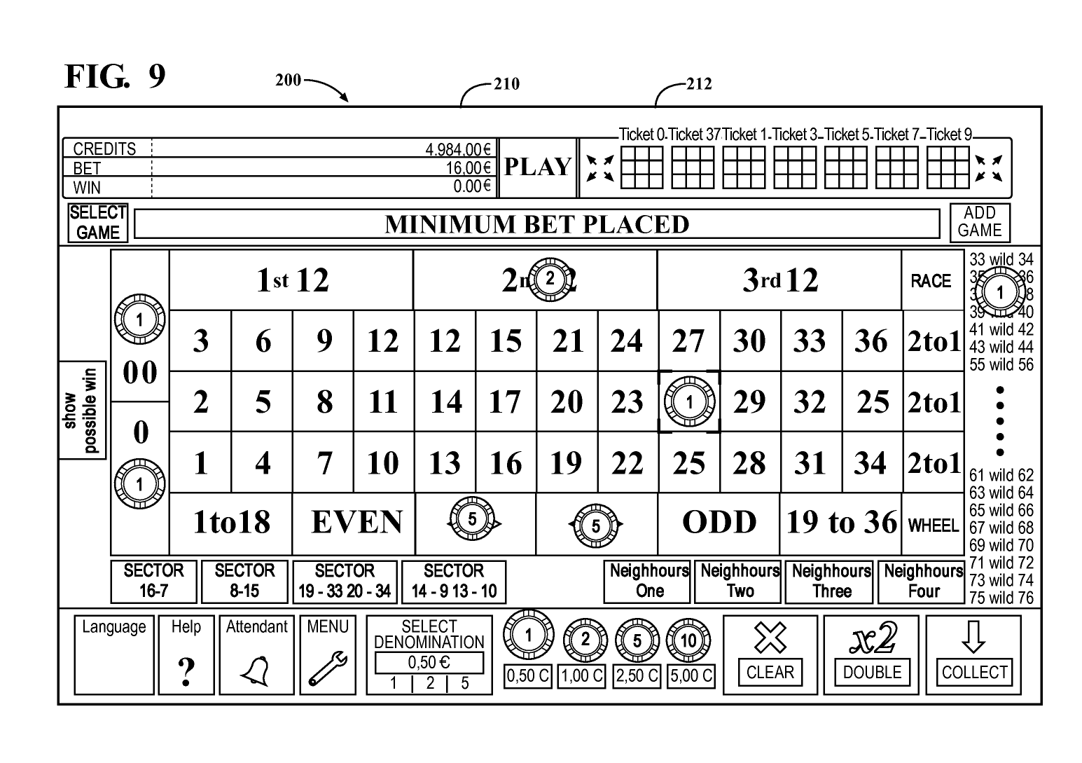

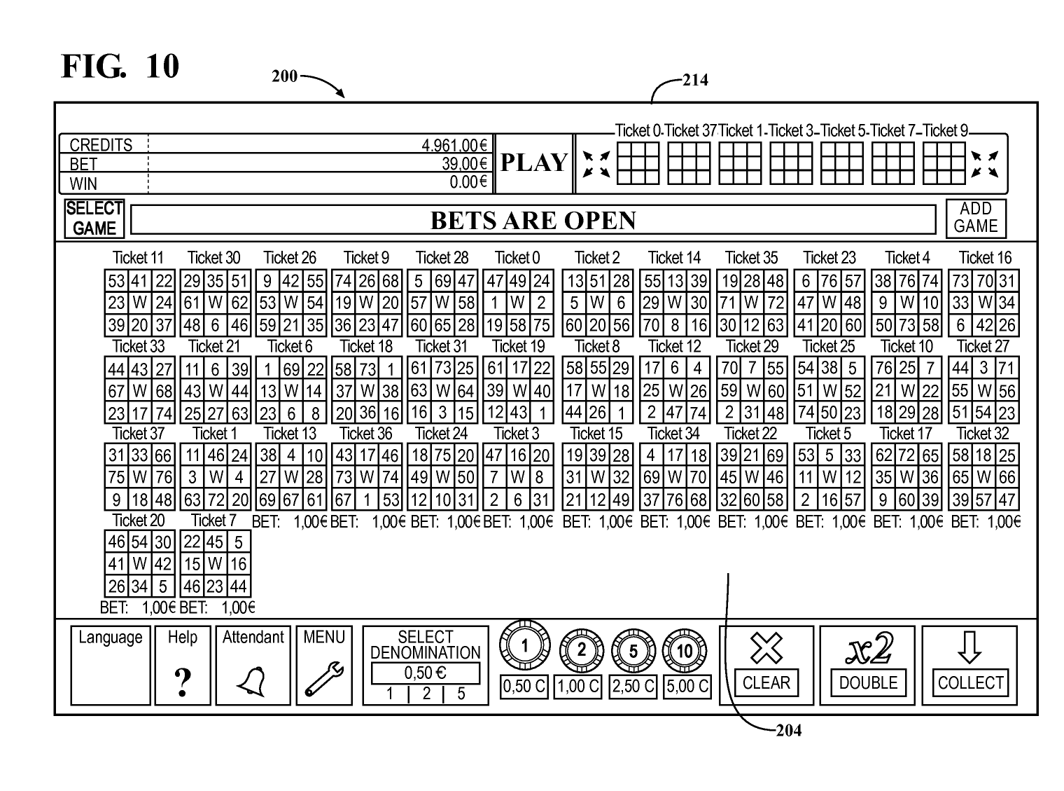

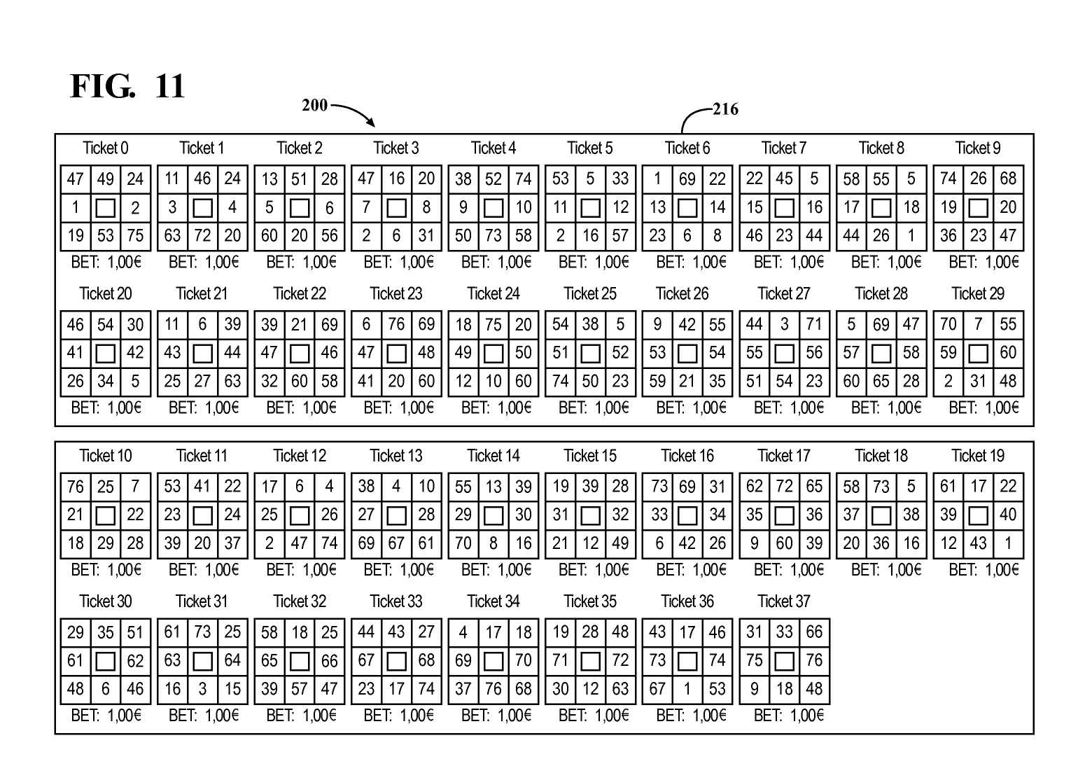

FIG. 7-11 provide graphical user interfaces or screens which may be displayed on game stations 12 having a touchscreen display in connection with another embodiment of the systems and methods of the invention generally referred to as game 200. It is envisioned that this embodiment would require two players as may be necessary. As such, wagers from at least two players must be received before game 200 will initiate.

Screen 202 includes a simulated roulette layout 204 in a condition prior to a wager to being placed in game 200. In this embodiment, a player must first place a wager on one of the main bingo cards shown from the main bingo card list 206 before any wagers may be placed on the roulette layout. Each of the main bingo cards is associated with first and second numbers and a space for a third number, wild, or free space, with the first and second numbers being the same numbers associated with and assigned to specific roulette outcomes as shown in FIG. 6. If the number is not a free space, then a third number must be randomly generated for any main bingo card to win.

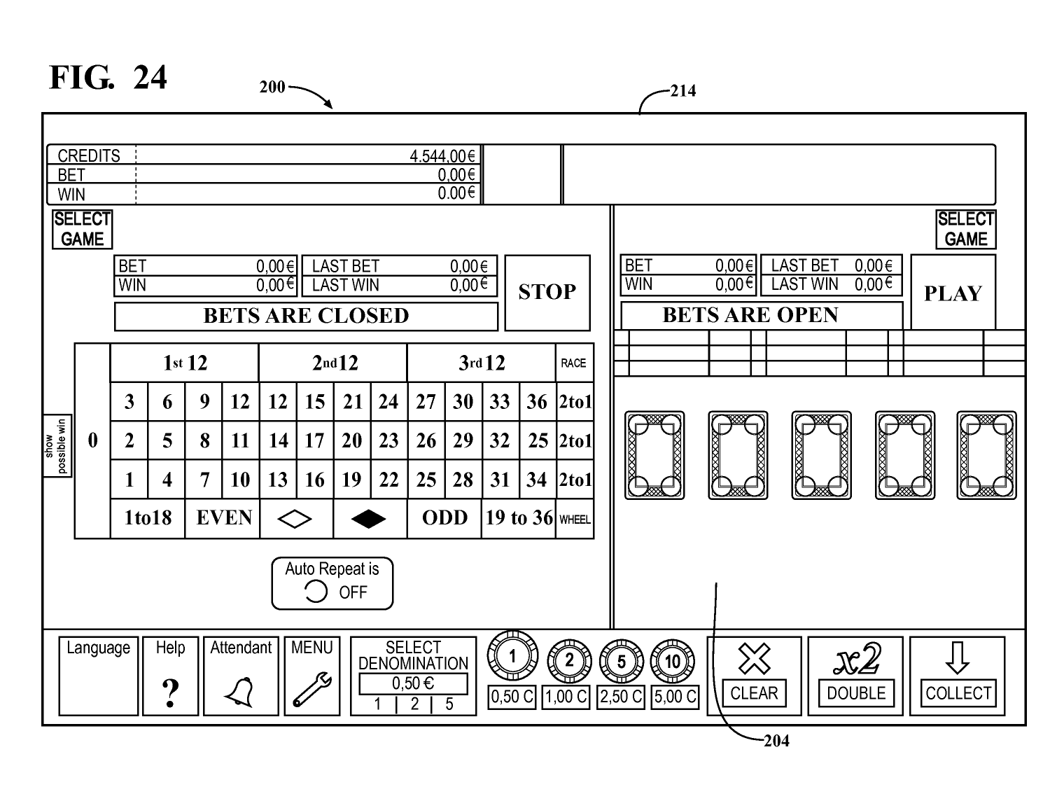

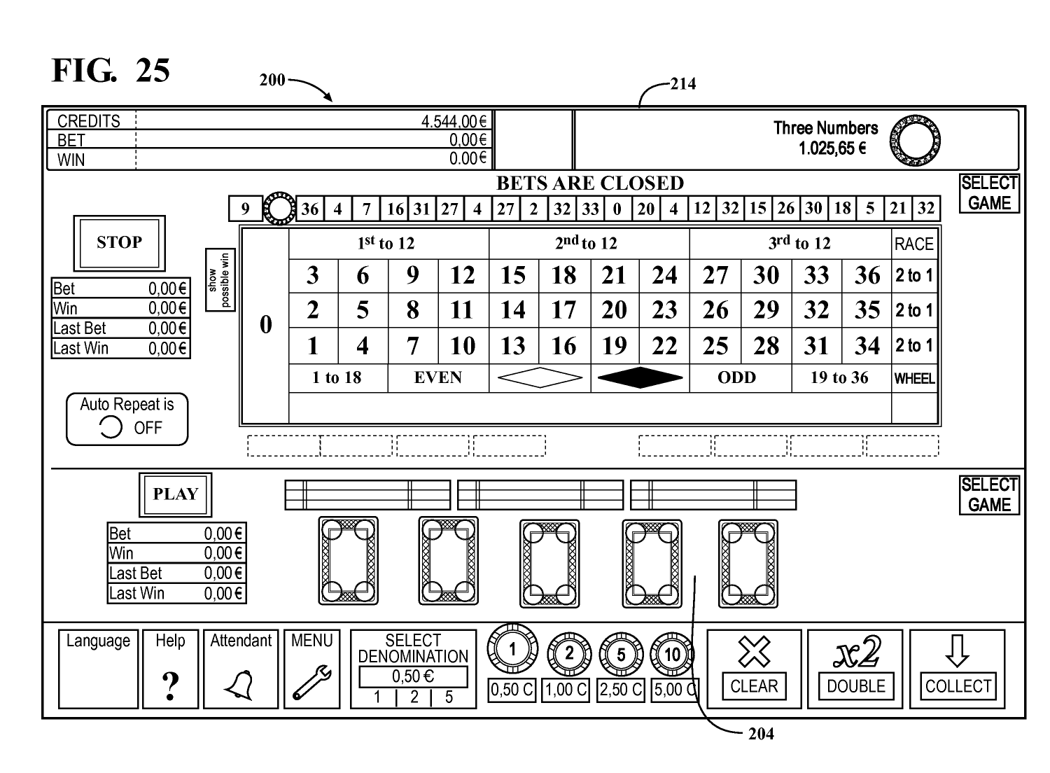

Screen 208 illustrates the condition of roulette layout 204 being available for receiving wagers subsequent to a wager being placed on a main bingo card in list 206, which is represented by a virtual one dollar chip on list 206. This layout would be visible as a game options during live gameplay by a player in either of the simultaneously screen configurations shown in FIG. 24 or 25.

Screen 210 illustrates the condition of additional wagers being placed on roulette layout 204, which are represented by the virtual chips displayed on “28,” “0”, “00,” “black”, “red” and “2^{nd} 12 numbers.” Controller 14 randomly generates three by three bingo tickets as shown in area 212 of screen 210. Each of the 3×3 bingo tickets include the assigned numbers for the specific outcome covered by the wager as the middle, horizontal line in the 3×3 bingo ticket.

For example, a wager on “26”, the 3×3 bingo ticket will include a middle horizontal line with the numbers 51 and 52. Wagers that include multiple roulette numbers, such as “black”, “red” and “2^{nd} 12 numbers,” or other inside or outside roulette bets, will be divided equally among the bingo tickets generated for each of the included roulette numbers. Payouts will be similarly adjusted and are based on the specific outcome being determined as one of the included roulette numbers. For example, $1 wagered on the “2^{nd} 12 numbers” bet will be divided by 12 representing the twelve possible numbers 13 through 24, so that $0.0833 will be effectively placed as a wager on each of the 3×3 tickets, with each of the tickets having the first and second numbers as shown in FIG. 6 associated with numbers 13 through 24 in the middle, horizontal line. Similarly, a corner wager would be divided by 4, representing the four possible roulette numbers included in the wager. While in some embodiments, the 3×3 tickets will be unique to each player or station 12, payouts on these wagers which include more than one specific roulette outcome, such as splits, corners, columns, or dozens wagers, will be paid to players only upon the specific outcome being one of the numbers included in the wager, just like in standard roulette. In some embodiments, players will share in the payout for winning wagers.

Screens 214 illustrates the thirty-eight bingo tickets generated by controller 14 (from ticket 0 to ticket 37) on the user interface 204, and screen 216 presents the tickets in sequential order, with each having the first and second unique numbers shown in FIG. 6 as the middle, horizontal line of each ticket. In this embodiment, tickets 37 and 38 represent the “0” and “00” possible roulette outcomes as shown in FIG. 6. For example, Ticket 26 includes first and second unique numbers 53, 54, which are assigned to the specific outcome of “27” for the roulette feature 16 to simulate.

In other embodiments, the ticket may be a 5×5 grid, with one or more free spaces. The winning bingo patterns may be straight across, up or down, L-shaped, diagonal, four corners, full coverage, etc., or otherwise include conventional winning patterns for bingo.

Multi Game Functionality

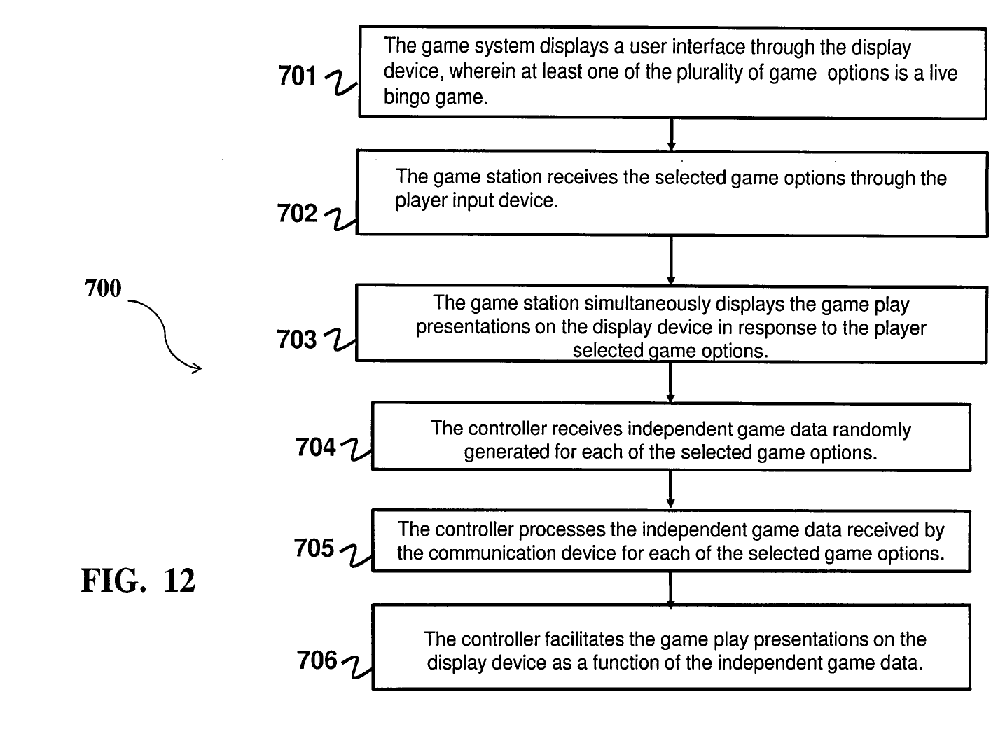

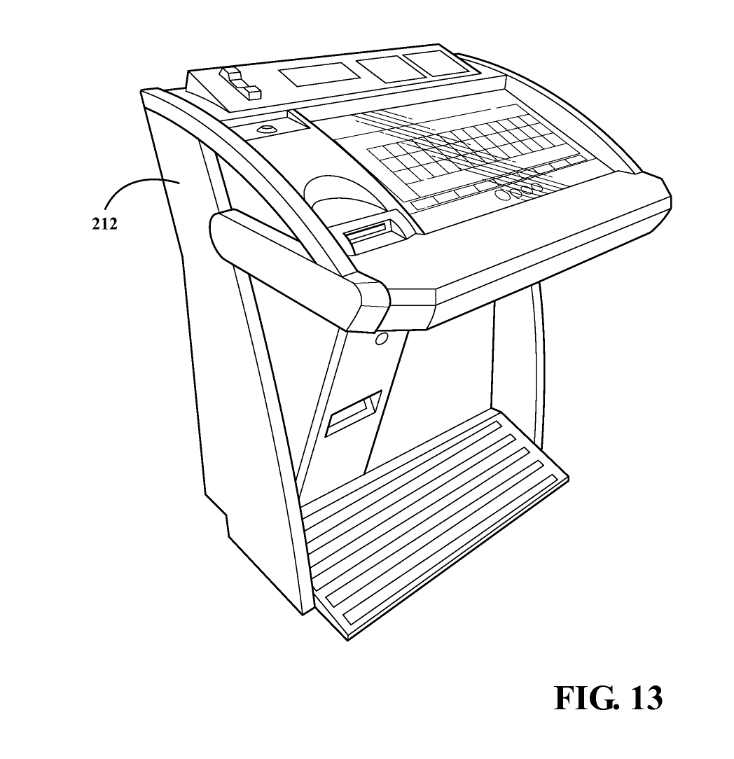

FIG. 12 shows an exemplary method 700 which may be utilized by system 10 to provide a game system with multiple game functionality. The method 700 includes at least one game station including a display device, a player input device in communication with the display device, a communication device, and a controller.

In some embodiments of the present invention the method 700 begins at step 701, where the game system displays a user interface through the display device. The user interface includes a plurality of game options available for selection. Each option is also associated with a game play presentation, wherein at least one of the plurality of game options is a live bingo game. The live bingo game can take the form of the simulated roulette bingo game discussed above but is not limited to that game type. Additional game options include any and all types of video or live action games including but not limited to card and dice based games.

Next, at step 702, the game system receives the selected game options selected by a player through the player input device. The player input device is in communication with the game stations either through wired or wireless communications standards and can access any of the selected game options available within the system. This step confirms the player's selection of the game option and indicates to the game system 10 that the player wishes to participate in the current wagering round of that particular game.

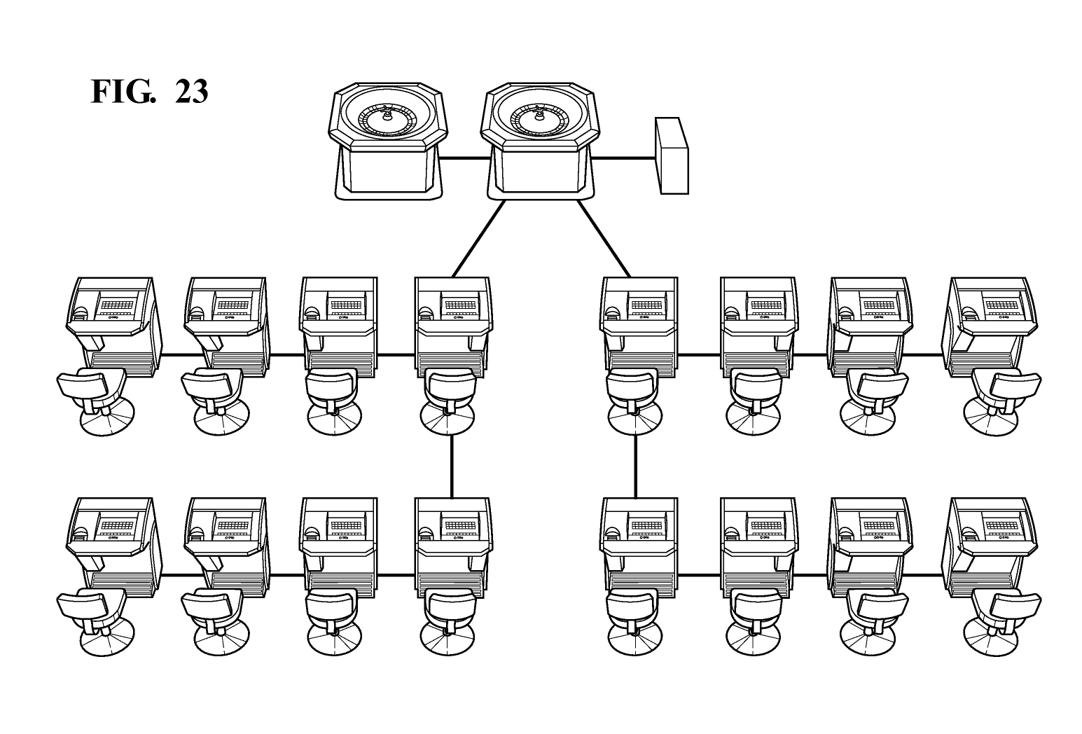

Then, at step 703, the game station 10 simultaneously displays game play presentations on the display device in response to the player selected game options. Examples of this are presented in FIG. 23 (showing a main game option with smaller satellite game options), FIG. 24 (showing two game options side by side), and FIG. 25 (showing two game options stacked across the display device).

At step 704 the controller receives independent game data randomly generated for each of the selected game options. This data can be from a current live game feature that is currently in progress or from a random number generator that is currently generating data for the particular game option selected. The game system 10 will allow the player to access any of game options available and therefore allow the controller 14 working with the game station 12 to receipt the independent game data that is related to game option selected. This independent game data may include wagering information, reward program information, or particular game mechanics related to the game play presentation.

Next, at step 705, the game controller 14 processes the independent game data received by the communications device for each of the selected game options. Here the game controller needs to parse out the game data and determine the options available to the player in order to continue playing within the game options selected.

Finally, at step 706, the controller facilitates the game play presentations on the display device as a function of the independent game date. This allows the player to the results of their current of game play for all the game options selected and decide on whether to not to continue with those game options, select other game options, or discontinue game play altogether.

### INDUSTRIAL APPLICATION

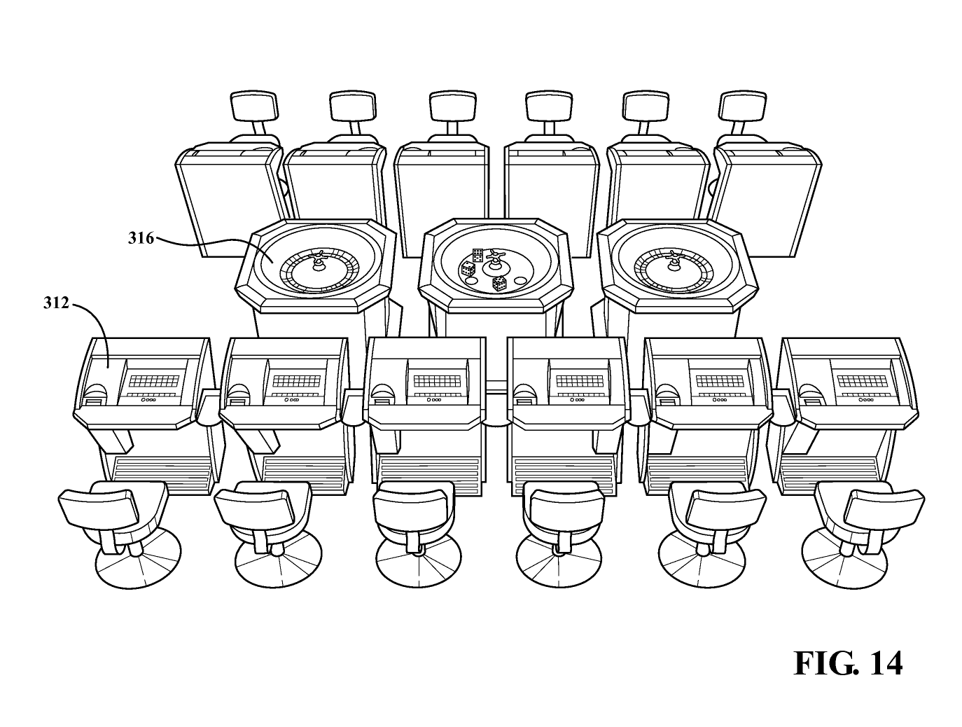

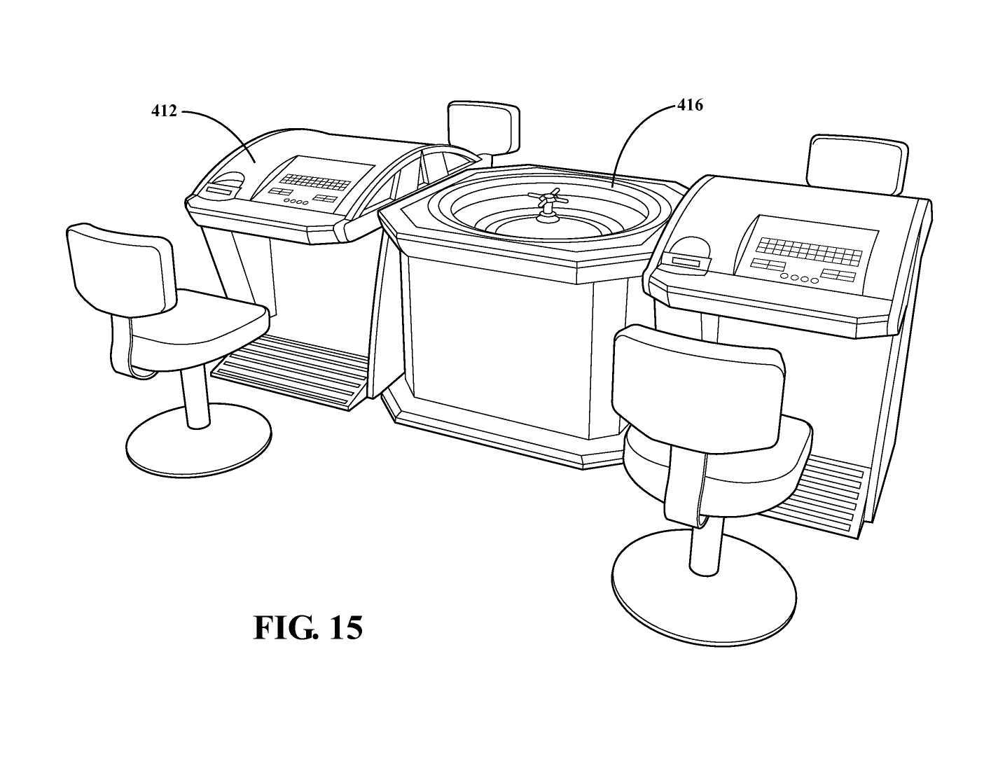

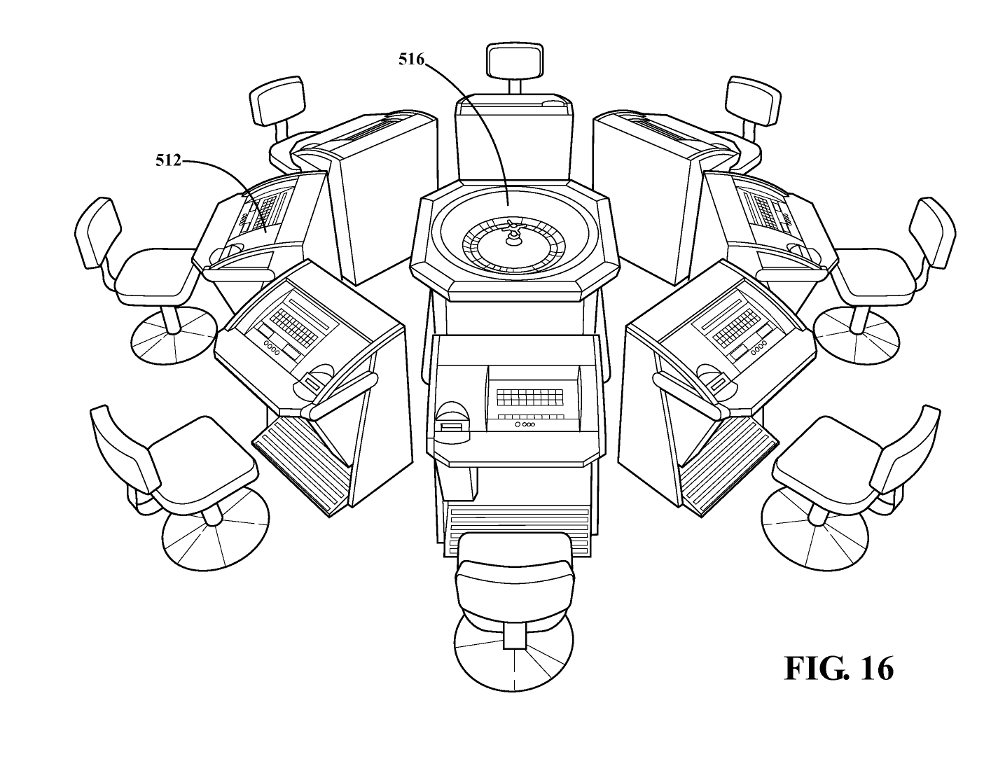

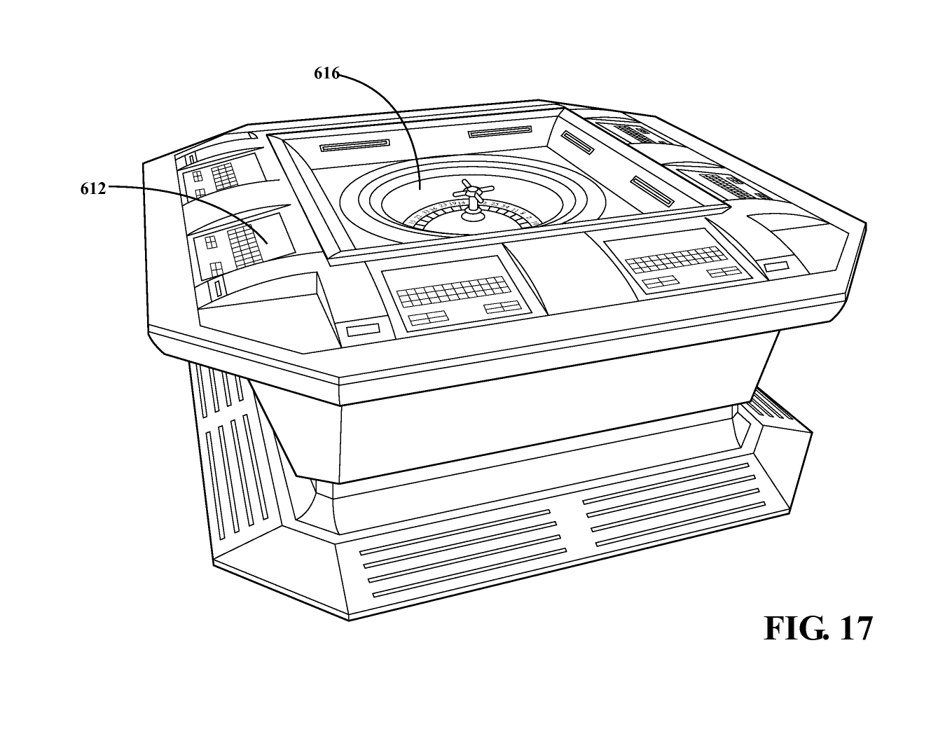

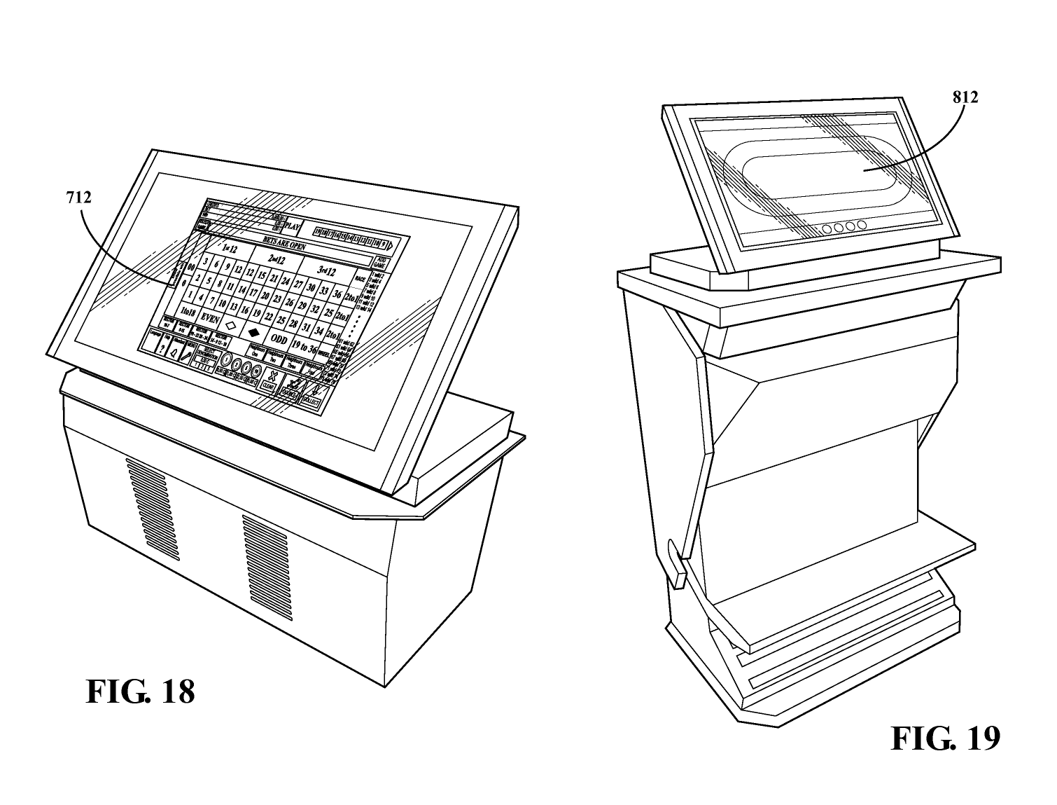

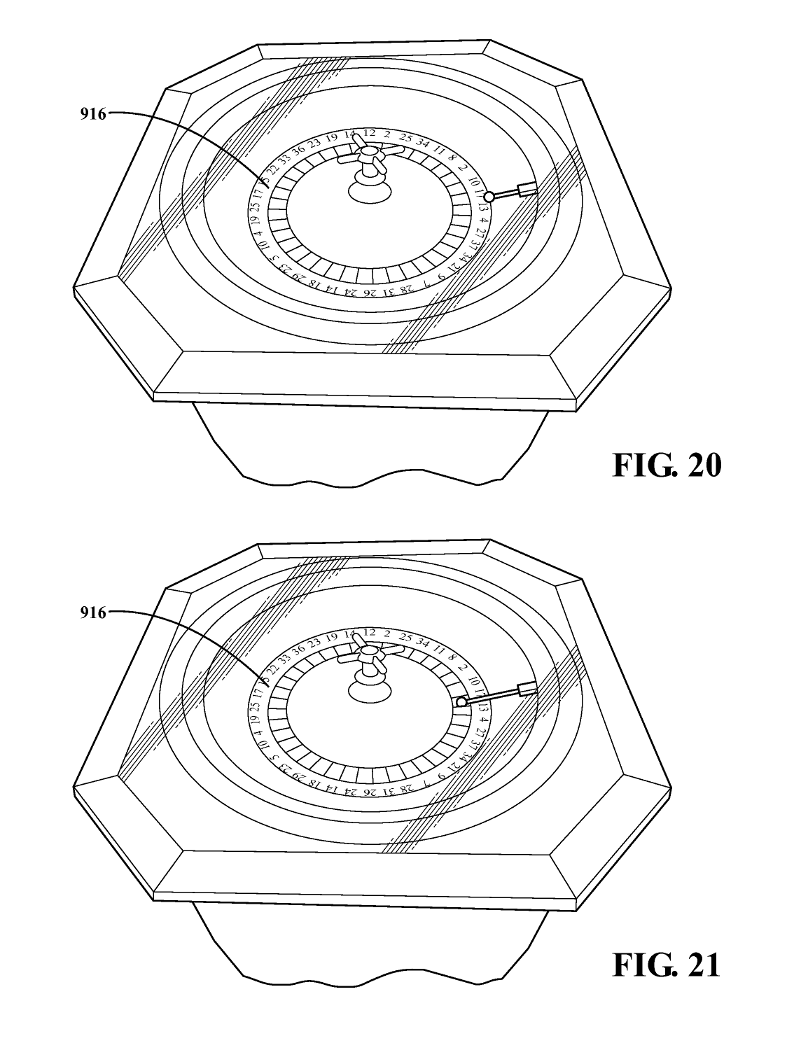

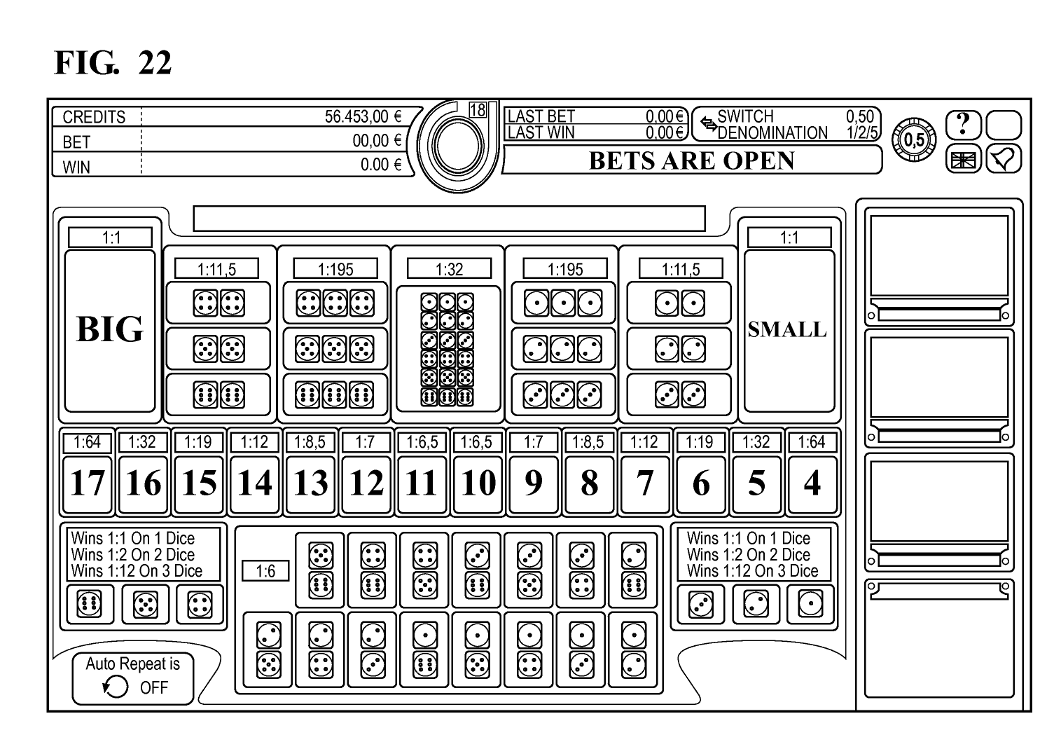

FIGS. 13 through 25 show multiple exemplary embodiments of the invention, including embodiments of game stations and live game features, which illustrate various industrial applications of the invention, among other things.

### GENERAL CONSIDERATIONS

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. The terms used herein, such as modules like display module, betting module, award module, servers, etc., are for ease in describing and illustrating features and operations of the invention and are not to be considered limiting in any way. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Those skilled in the art will readily appreciate that the systems and methods described herein may be a standalone system or incorporated in an existing gaming system. The system of the invention may include various computer and network related software and hardware, such as programs, operating systems, memory storage devices, data input/output devices, data processors, servers with links to data communication systems, wireless or otherwise, and data transceiving terminals. It should also be understood that any method steps discussed herein, such as for example, steps involving the receiving or displaying of data, may further include or involve the transmission, receipt and processing of data through conventional hardware and/or software technology to effectuate the steps as described herein. Those skilled in the art will further appreciate that the precise types of software and hardware used are not vital to the full implementation of the methods of the invention so long as players and operators thereof are provided with useful access thereto, either through a mobile device, gaming platform, or other computing platform via a local network or global telecommunication network.

Although specific features of various embodiments of the invention may be shown in some drawings and not in others, this is for convenience only. In accordance with the principles of the invention, any feature of a drawing may be referenced and/or claimed in combination with any feature of any other drawing.

While exemplary systems and methods in accordance with the invention have been described herein and in the accompanying materials, it should also be understood that the foregoing along with the accompanying materials are illustrative of a few particular embodiments as well as principles of the invention, and that various modifications can be made by those skilled in the art without departing from the scope and spirit of the invention. Therefore, the described embodiments should not be considered as limiting of the invention in any way. Accordingly, the invention embraces alternatives, modifications and variations which fall within the spirit and scope of the invention as set forth in the claims, including equivalents thereto.

What is claimed is:

1. A game system with multiple game functionality comprising:
at least one game station including a display device configured to display a user interface, the user interface including a plurality of game options available for selection, each game option being associated with a game play presentation, wherein at least one of the plurality of game options is a live bingo game;
a player input device in communication with the display device and configured for receiving selected game options, wherein game play presentations are displayed simultaneously on the display device responsive to the player selected game options;
a communication device for receiving independent game data randomly generated for each of the selected game options; and
a controller for processing the independent game data received by the communication device for each of the selected game options and facilitating independent game play presentations on the display device as a function of the independent game data.

2. The game system recited in claim 1, wherein the at least one game station further includes a random number generator configured to generate independent game data in response to a player selected game option within the system.

3. The game system recited in claim 1, the system further including a system controller configured to correlate the independent game data with the game option selected at the at least one game station.

4. The game system recited in claim 1, each game station further configured to automatically place a wager on the at least one game option available within the system through the at least one game station in response to the independent game data.

5. A method of implementing a game system with multiple game functionality including at least one game station including a display device, a player input device in communication with the display device, a communication device, and a controller, the method comprising the steps of:
displaying a user interface through the display device, the user interface including a plurality of game options available for selection, each game option being associated with a game play presentation, wherein at least one of the plurality of game options is a live bingo game;
receiving selected game options through the player input device;
simultaneously displaying game play presentations on the display device in response to the player selected game options;
receiving independent game data randomly generated for each of the selected game options;
processing the independent game data received by the communication device for each of the selected game options; and
facilitating the game play presentations on the display device as a function of the independent game data.

6. The method recited in claim 5, wherein the at least one game station further includes a random number generator and the method including the step of generating independent game data in response to a player selected game option within the system.

7. The method recited in claim 5, the system further including a system controller and the method further including the step of correlating the independent game data with the game option selected at the at least one game station.

8. The method recited in claim 5, the method further including the step of automatically placing a wager on the at least one game option available within the system through the at least one game station in response to the independent game data.

9. A non-transitory information recording medium on which a computer readable program is recorded that causes a computer to function as a game system with multiple game functionality comprising:
at least one game station including a display device configured to display a user interface, the user interface including a plurality of game options available for selection, each game option being associated with a game play presentation, wherein at least one of the plurality of game options is a live bingo game;
a player input device in communication with the display device and configured for receiving selected game options, wherein game play presentations are displayed simultaneously on the display device responsive to the player selected game options;
a communication device for receiving independent game data randomly generated for each of the selected game options; and
a controller for processing the independent game data received by the communication device for each of the selected game options and facilitating independent game play presentations on the display device.
